(19) United States
(12) Patent Application Publication
(10) Pub. No.: US 2018/0209706 A1
(43) Pub. Date: Jul. 26, 2018

(54) EJECTOR JOINT STRUCTURE

(71) Applicant: ASIAN FIRST REFRIGERATION CORPORATION, TAICHUNG CITY (TW)

(72) Inventor: SHENG CHIH CHIU, TAICHUNG CITY (TW)

(21) Appl. No.: 15/648,793

(22) Filed: Jul. 13, 2017

Related U.S. Application Data
(63) Continuation-in-part of application No. 15/456,699, filed on Mar. 13, 2017.

(30) Foreign Application Priority Data
Jan. 24, 2017 (TW) 106201277

(51) Int. Cl. F25B 45/00; F16L 29/00; F16L 15/00; F16K 1/12

(52) U.S. Cl. CPC F25B 45/00; F16L 29/007; F25B 2345/001; F16K 1/12; F25B 2345/006; F16L 15/006

(57) ABSTRACT

An ejector joint structure includes first and second connection members and an ejector. The first connection member has a head portion, a body portion, and a defined-through first channel. The first channel has a stepped portion and forms a thick section and a thin section. The body portion has a through-hole communicating with the thin section. The ejector is movably threaded in the first channel via an abutting rod. The abutting rod has a flange corresponding to the thick section and selectively abutted against the stepped portion to shield the first channel. The second connection member has a sleeve to enclose an outer periphery of the first connection member, and the second connection member is rotatable relative to the first connection member. The sleeve has a second channel communicating with the hollowed space. A sealing member is assembled between the sleeve and the body portion to seal the hollowed space.

### REFERENCE TO RELATED APPLICATIONS

This Application is being filed as a Continuation-in-Part of application Ser. No. 15/456,699, filed 13 Mar. 2017, currently pending.

### BACKGROUND OF THE INVENTION

### Field of the Invention

The present invention relates to a joint structure, in particular to joint structure with an ejector.

### Description of the Prior Art

As shown in FIG. 5, in an occasion for pouring refrigerants into an air conditioner via a coolant pipeline, an end portion of the coolant pipeline 5 has a connection head 6 connected to a connection port 7 of the air conditioner via threads. An ejector 61 is in the connection head 6, and a valve member 71 is in the connection port 7. When the connection head 6 is locked to the connection port 7 and the connection head 6 is connected to the connection port 7, the ejector 61 pushes the valve member 71 to output the refrigerants from a high pressure reservoir (for example, a steel bottle) via the coolant pipeline 5 and further pours the refrigerants into the connection port 7.

After the filling procedure of the refrigerants is finished, the operator has to detach the connection head 6 of the coolant pipeline 5 from the connection port 7 of the air conditioner. In general, the operator contacts and rotates the connection head 6 by tools or bare hands. However, high-pressure refrigerants may still be left in the coolant pipeline 5, the refrigerants may be released from the connection head 6 quickly, and the quick-sprayed refrigerants may hurt the operator's hands. On the other hand, when the coolant pipeline 5 is detached from the air conditioner, the amount of the released refrigerants equals to the volume of the whole coolant pipeline 5. As a result, in the conventional, the amount of the released and wasted refrigerants is too many.

### SUMMARY OF THE INVENTION

One object of the present invention is to provide an ejector joint structure, the ejector of the structure can be operated and extended outward, and the ejector can be controlled to be moved along with the connection port. Hence, the ejector joint structure can be connected to and detached from the pipeline, and the risk of getting hurt by the high pressure fluid can be reduced during detaching the ejector joint structure from the pipeline.

In view of these objects, the present invention provides an ejector joint structure comprising:

a first connection member having a head portion and a body portion connected to the head portion, wherein a first channel is defined through the head portion toward the body portion, the first channel has a connection groove at one end of the head portion for communicating with an external pipeline receiving space, and the connection groove has a first threaded portion, the first channel has a stepped portion, so that the first channel forms a thick section and a thin section, the thin section has a second threaded portion, the body portion has a through hole communicating with the thin section, and the stepped portion is closer to the head portion than the through hole;

an ejector having an abutting rod extending toward the first channel, wherein the abutting rod has a third threaded portion corresponding to the thin section and threaded with the second threaded portion, so that the abutting rod is movable in the first channel by rotation, the abutting rod has a flange corresponding to the thick section, the flange is movable along with the abutting rod, and the flange is selectively abutted against the stepped portion to shield the first channel, the abutting rod has an operating portion located out of the first channel;

a second connection member having a sleeve and a manifold for connecting to the external pipeline, the sleeve encloses a hollowed space, and the manifold comprises a second channel communicating with the hollowed space, the sleeve encloses an outer periphery of the body portion of the first connection member and the sleeve is rotatable relative to the body portion, and a sealing member is assembled between the sleeve and the body portion, and the sealing member seals the hollowed space.

In one embodiment, the operating portion and the connection groove are spaced by a safety distance.

In one embodiment, one end of the body portion has a separation member being movable, when the abutting rod of the ejector is moved and inserted into the connection groove, the operating portion is just abutted against the separation member.

In one embodiment, the operating portion has a recess at one side thereof and facing the body portion, when the abutting rod is moved and inserted into the connection groove, the recess of the operating portion encloses out of one end of the body portion.

In one embodiment, the separation member is a washer or a roller bearing.

In one embodiment, an annular groove is formed on the outer periphery of the body portion or on an inner periphery of the sleeve for engaging with the sealing member.

### BRIEF DESCRIPTION OF THE DRAWINGS

FIG. 1 illustrates an exploded view of an ejector joint structure according to the present invention;

FIGS. 2 to 4 illustrate sectional as well as operational views of the ejector joint structure according to the present invention; and

FIG. 5 illustrates an operational view of a conventional ejector joint structure.

### DETAIL DESCRIPTION OF THE PREFERRED EMBODIMENTS

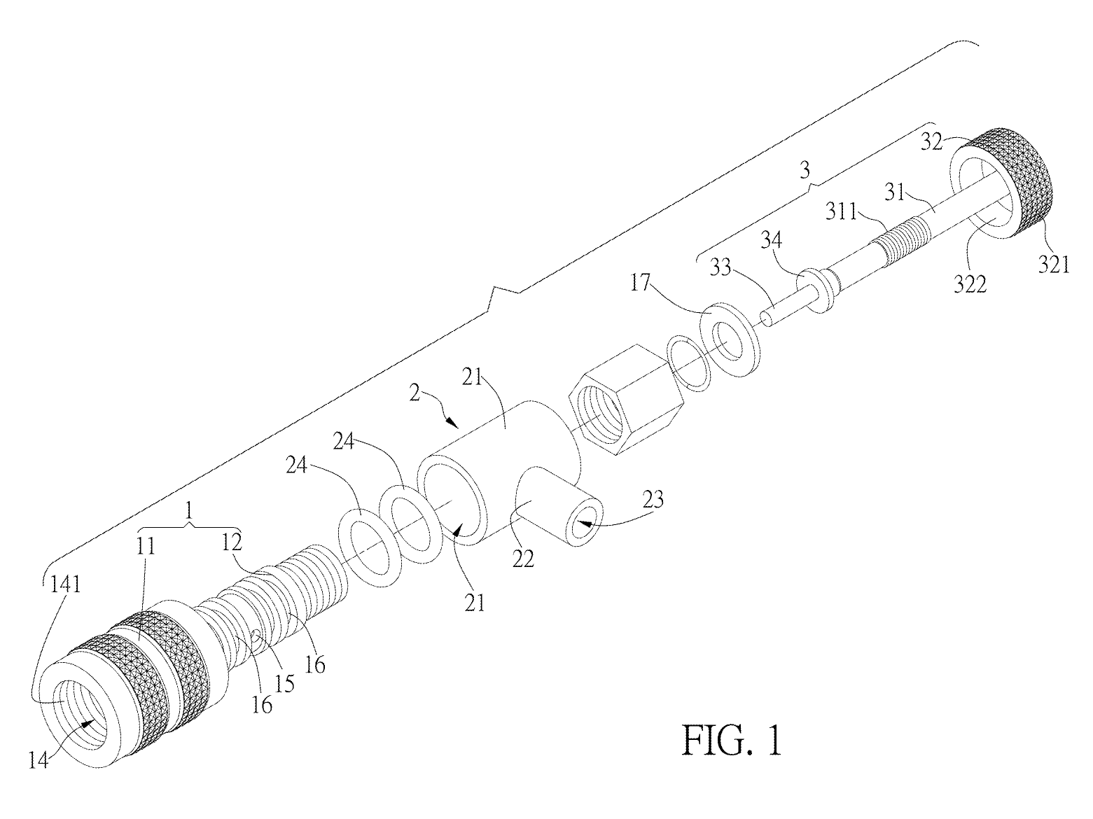

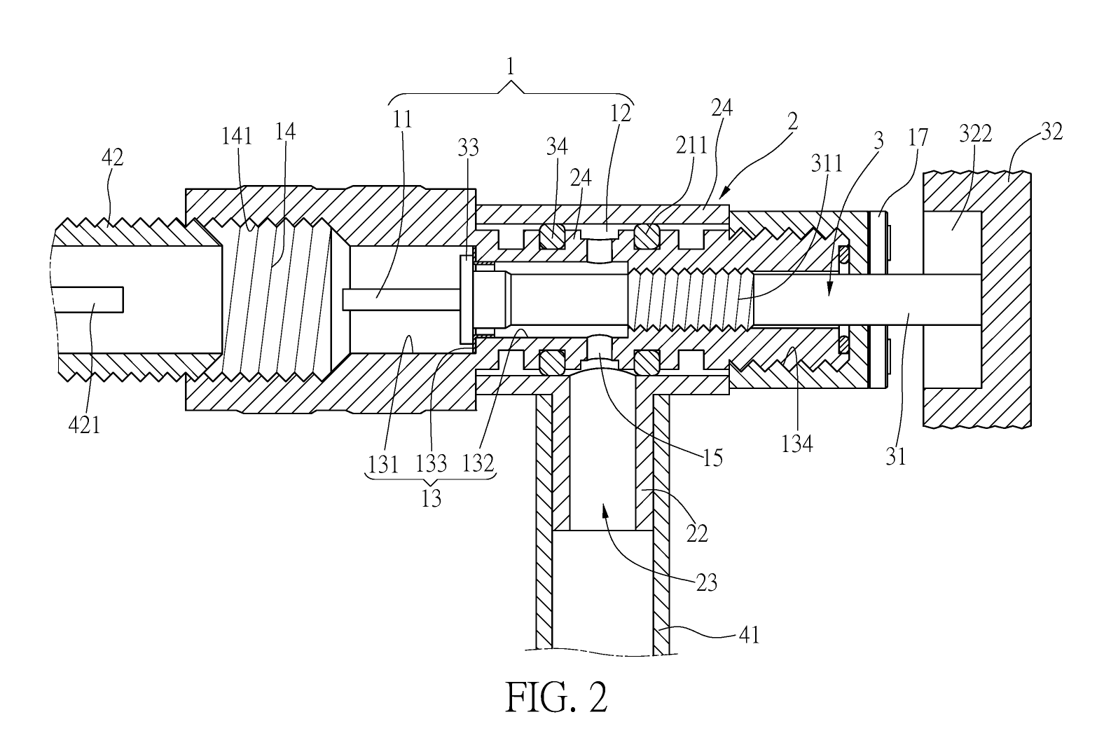

Please refer to FIGS. 1 and 2, illustrating an ejector joint structure according to the present invention. The ejector joint structure comprises a first connection member 1, a second connection member 2, and an ejector 3. The first connection member 1 has a head portion 11 and a body portion 12 connected to the head portion 11. A first channel 13 is defined through the head portion 11 toward the body portion 12, so that the first connection member 1 is tubular shaped. The first channel 13 has a connection groove 14 at one end of the head portion 11, the connection groove 14 has a first threaded portion 141 and the connection groove 14 is used to be connected to an external pipeline.

The first channel 13 has different inner diameters respectively corresponding to the head portion 11 and the body portion 12. The first channel 13 has a thick section 131 with greater inner diameter and corresponding to the head portion 11 and a thin section 132 with a smaller inner diameter and corresponding to the body portion 12. A stepped portion 133 is formed on a connection between the thick section 131 and the thin section 132. The thin section 132 has a second threaded portion 134. An outer surface of the body portion 12 has a through hole 15 communicating with the thin section 132. The stepped portion 133 is closer to the head portion 11 than the through hole 15.

The ejector 3 has an abutting rod 31. One of two ends of the abutting rod 31 has an operating portion 32, and the other end of the abutting rod 31 has an abutting portion 33. The abutting rod 31 has a third threaded portion 311. The abutting rod 31 of the ejector 3 passes through the first channel 13, and the third threaded portion 311 is movably threaded with the second threaded portion 134 of the thin section 132. The operating portion 32 is out of the thin section 132, and the operating portion 32 and the connection groove 14 are spaced by a safety distance. The size of the operating portion 32 is suitable for operation, and the operating portion 32 has a antiskid pattern 321 on an outer periphery of the operating portion 32, so that an operator can operate the ejector 3 via the operating portion 32 in a convenient way, and the ejector 3 can be moved in the first channel 13 via the threads. One end of the body portion 12 has a separation member 17, and the separation member 17 is movably fitted over the abutting rod 31 and corresponding to the operating portion 32. The separation member 17 may be a washer or a roller bearing. Furthermore, the operating portion 32 has a recess 322 at one side thereof and facing the body portion 322.

The abutting rod 31 has a flange 34 extending toward the thick section 131, and the flange 34 is movable in the thick section 131 along with the abutting rod 31, an outer diameter of the flange 34 is greater than an inner diameter of the thin section 132. Therefore, the flange 34 can be stopped by the stepped portion 133 and abutted against the stepped portion 133. Hence, the first channel 13 can be shielded by the flange 34.

The second connection member 2 has a sleeve 21, and the sleeve 21 encloses a hollowed space 211. A manifold 22 is extending from a side portion of the sleeve 21 for connecting to the external pipeline. Hence, the second connection member 2 is T shaped. The manifold 22 comprises a second channel 23 communicating with the hollowed space 211.

Moreover, an inner diameter of the sleeve 21 is slightly greater than an outer diameter of the body portion 12, so that the sleeve 21 of the second connection member 2 encloses an outer periphery of the body portion 12. In other words, the body portion 12 is inserted into the hollowed space 211 of the sleeve 21, and an end portion of the body portion 12 extends out of the hollowed space 211, so that the first connection member 1 is rotatable relative to the sleeve 21. Two ends of the hollowed space 211 are respectively sealed by two sealing members 24. The sealing member 24 may be a rubber ring assembled between the sleeve 21 and the body portion 12, and an annular groove 16 is formed on the outer periphery of the body portion 12 or on the inner periphery of the sleeve 21 for receiving the sealing member 24. In this embodiment, the annular groove 16 is formed on the outer periphery of the body portion 12.

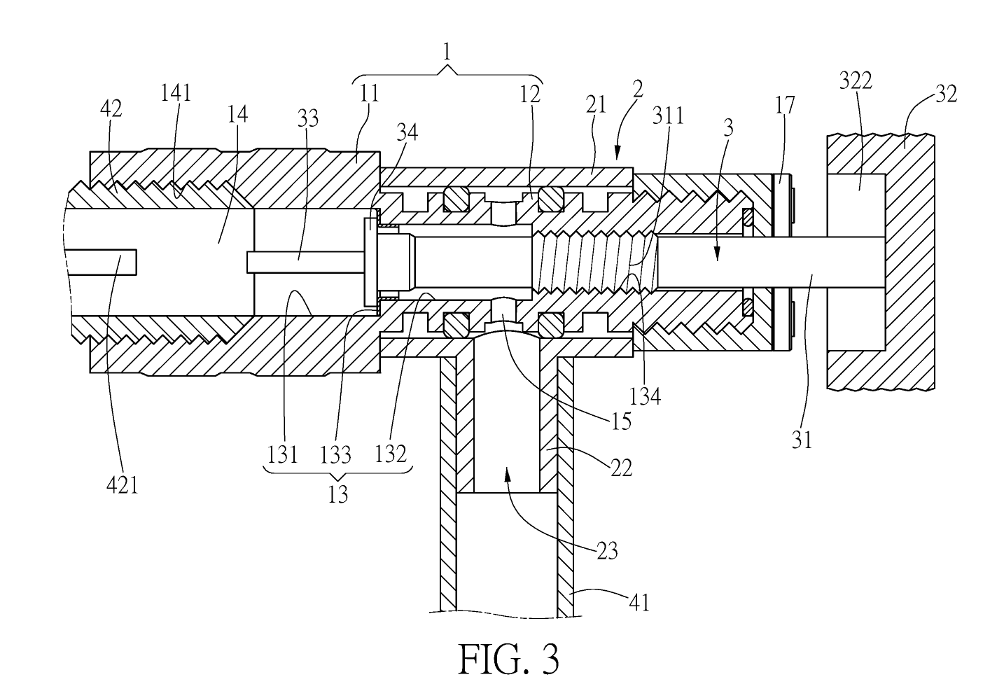

Accordingly, the ejector joint structure can be used for pressure pipelines delivering different pressure fluids, for example, air, oil, or refrigerants. The operation scenarios are illustrated in FIGS. 2 to 4. In an occasion for pouring the refrigerants into an air conditioner, as shown in FIG. 2, firstly, the ejector 3 is moved to allow the flange 34 abutting against the stepped portion 133 by rotating the operating portion 32. Then, the operating portion 32 is further rotated so that the first channel 13 is firmly shielded by the flange 34. On the other hand, a pipeline 41 supplying the refrigerants is connected to the manifold 22 of the second connection member 2. Next, the connection groove 14 of the first connection member 1 is threaded to a connection port 42 of the air conditioner. Before the connection groove 14 is securely threaded with the connection port 42, since the third threaded portion 311 of the ejector 3 is securely threaded with the second threaded portion 134 of the first channel 13 to generate friction, the operator can just rotate the operating portion 32, so that the abutting rod 31 drives the first connection member 1 to rotate along with the rotation of the operating portion 32. Hence, the connection groove 14 is threaded with the connection port 42 as shown in FIG. 3. Because the first connection member 1 is inserted into the sleeve 21 of the second connection member 2, the rotation of the first connection member 1 does not affect the second connection member 2 and the pipeline 41 connected to the second connection member 2.

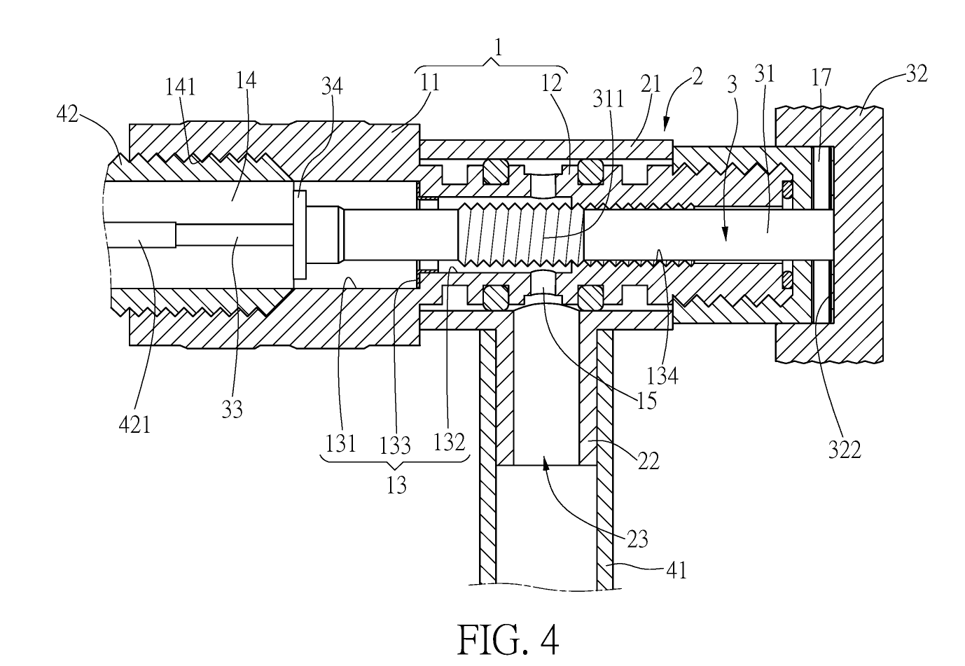

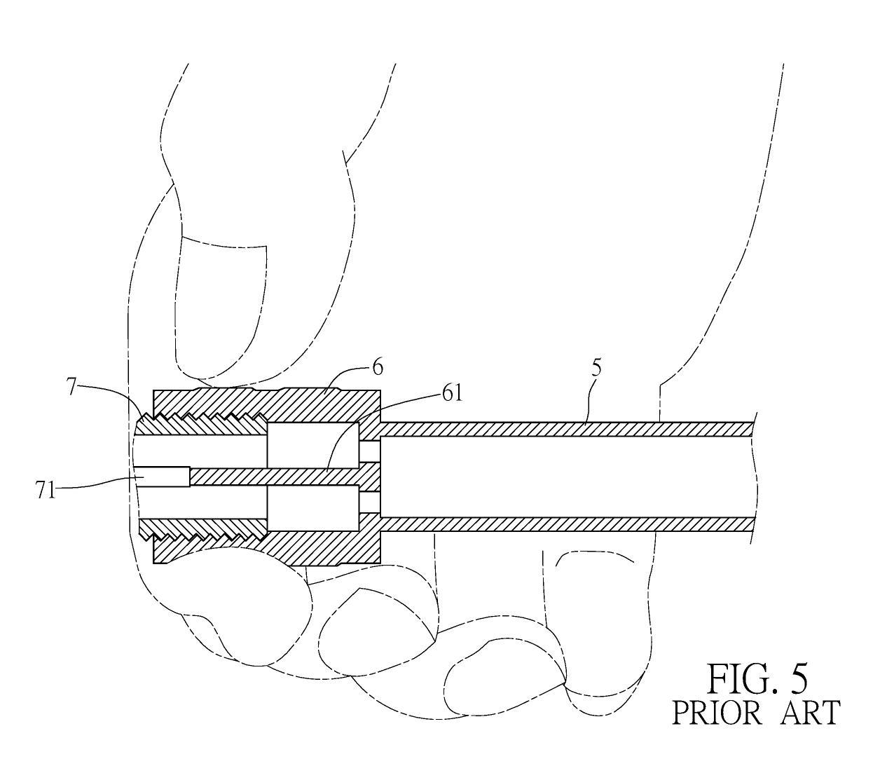

After the connection groove 14 is threaded with the connection port 42, the first connection member 1 is fixed with the connection port 42 and cannot be rotated anymore. However, the friction between the third threaded portion 311 and the second threaded portion 134 can be overcome when the operating portion 32 is further rotated, so that the ejector 3 is unlocked and can be rotated relative to the first connection member 1 as shown in FIG. 4. Hence, the ejector 3 can be threaded out of the second threaded portion 134 to have a displacement, and the abutting portion 33 of the ejector 3 is inserted into the connection groove 14 to push away a valve member 421 in the connection port 42. Then, the flange 34 of the ejector 3 is detached from the stepped portion 13, and the pipeline 41 can be in communication with the first channel 13 via the second channel 23 and the through hole 15. Accordingly, the refrigerants can be poured into the air conditioner via such path. On the other hand, when the abutting portion 33 of the ejector 3 is moved and inserted into the connection groove 14 to push away the valve member 421, the operating portion 32 just encloses one end of the body portion 12 and the operating portion 32 is abutted against the separation member 17.

After the filling procedure of the refrigerants is finished, the operator detaches the ejector joint structure from the connection port 42 with foregoing steps in a reversed manner In detail, the operator rotates the operating portion 32 in an opposite manner shown in FIG. 4. Because the friction between the threads of connection groove 14 of the first connection member 1 and the threads of the connection port 42 is relatively greater than the friction between the threads of the abutting rod 31 and the threads of the thin section 132, the ejector 3 is threaded into the second threaded portion 134, so that the abutting portion 33 is detached from the valve member 421 of the connection port 42 and to be in a state as shown in FIG. 3. During the operation, because the operating portion 32 is abutted against the separation member 17, and the separation member 17 is movable relative to the body portion 12, the friction between the separation member 17 and the body portion 12 is relatively small. Hence, when the operating portion 32 is rotated, the first connection member 1 is not rotated due to successive friction.

Then, the operating portion 32 is further rotated, because the flange 34 of the ejector 3 is closely abutted against the stepped portion 133 and the abutting rod 31 is securely threaded with the second threaded portion 134, and the ejector 3 is not rotated relative to the first connection member 1, so that the first connection member 1 is rotated along with the rotation of the operating portion 32 and the first connection member 1 is out of the connection port 42 and back to a state as shown in FIG. 2. Hence, the connection port 42 is detached from the connection groove 14.

Accordingly, during the assembling and the disassembling process, the operator just need to operate the operating portion 32 to complete the steps without using tools or bare hands at the head portion 11 for assembling or disassembling. Therefore, the operator can be prevented from being hurt by the high pressure refrigerants left in the pipeline during the operation. The operating portion 32 and the connection groove 14 are spaced by a safety space, so that the safety of the filling procedure can be ensured.

Furthermore, after the filling of the refrigerants is completed, and the ejector joint structure is to be detached from the connection port 42, as shown in FIG. 3, the valve member 421 of the connection port 42 is closed and the flange 34 of the ejector 3 is closely abutted against the stepped portion 133 to shield the first channel 13. Hence, after the ejector joint structure is detached from the pipeline, the amount of the left refrigerants is the volume of the thick section 131. Therefore, for the operator, the risk of getting hurt can be reduced. Moreover, the amount of the released and wasted refrigerants can be reduced.

What is claimed is:

1. An ejector joint structure, comprising:
a first connection member having a head portion and a body portion connected to the head portion, wherein a first channel is defined through the head portion toward the body portion, the first channel has a connection groove at one end of the head portion for communicating with an external pipeline receiving space, and the connection groove has a first threaded portion, the first channel has a stepped portion, so that the first channel forms a thick section and a thin section, the thin section has a second threaded portion, the body portion has a through hole communicating with the thin section, and the stepped portion is closer to the head portion than the through hole;
an ejector having an abutting rod extending toward the first channel, wherein the abutting rod has a third threaded portion corresponding to the thin section and threaded with the second threaded portion, so that the abutting rod is movable in the first channel by rotation, the abutting rod has a flange corresponding to the thick section, the flange is movable along with the abutting rod, and the flange is selectively abutted against the stepped portion to shield the first channel, the abutting rod has an operating portion located out of the first channel;
a second connection member having a sleeve and a manifold for connecting to the external pipeline, the sleeve encloses a hollowed space, and the manifold comprises a second channel communicating with the hollowed space, the sleeve encloses an outer periphery of the body portion of the first connection member and the sleeve is rotatable relative to the body portion, and a sealing member is assembled between the sleeve and the body portion, and the sealing member seals the hollowed space.

2. The ejector joint structure according to claim 1, wherein the operating portion and the connection groove are spaced by a safety distance.

3. The ejector joint structure according to claim 1, wherein one end of the body portion has a separation member being movable, when the abutting rod of the ejector is moved and inserted into the connection groove, the operating portion is just abutted against the separation member.

4. The ejector joint structure according to claim 3, wherein the separation member is a washer or a roller bearing.

5. The ejector joint structure according to claim 3, wherein the operating portion has a recess at one side thereof and facing the body portion, when the abutting rod is moved and inserted into the connection groove, the recess of the operating portion encloses out of one end of the body portion.

6. The ejector joint structure according to claim 5, wherein the separation member is a washer or a roller bearing.

7. The ejector joint structure according to claim 1, wherein, an annular groove is formed on the outer periphery of the body portion or on an inner periphery of the sleeve for engaging with the sealing member.
